(19) United States
(12) Patent Application Publication
(10) Pub. No.: US 2008/0242297 A1
(43) Pub. Date: Oct. 2, 2008

(54) METHOD FOR SEARCHING FOR NETWORK IN RADIO COMMUNICATION SYSTEM

(76) Inventors: Yong Noh LEE, Cheonan-si (KR); Chang Ho SOHN, Seongnam-si (KR)

Correspondence Address: CHA & REITER, LLC, 210 ROUTE 4 EAST STE 103, PARAMUS, NJ, 07652, US

(21) Appl. No.: 12/058,978

(22) Filed: Mar. 31, 2008

(30) Foreign Application Priority Data
Apr. 2, 2007 (KR) 2007-0032182

(51) Int. Cl. H04Q 7/20

(52) U.S. Cl. 455/434

(57) ABSTRACT

A method for improving the network search rate by reducing the manual network search time in a radio communication system. System information messages are periodically broadcast, and the messages include a Master Information Block (MIB) containing location area information regarding at least one Public Land Mobile Network (PLMN). The MIB of the system information message received from the network is read during a network search by a User-Equipment (UE), displaying a PLMN list, and reading a System Information Block (SIB) of a PLMN selected from the PLMN list.

### CLAIM OF PRIORITY

This application claims priority under 35 U.S.C. §119(a) from an application entitled “METHOD FOR SEARCHING FOR NETWORK IN RADIO COMMUNICATION SYSTEM” filed in the Korean Intellectual Property Office on Apr. 2, 2007 and assigned Serial No. 2007-0032182, the contents of which are incorporated herein by reference in its entirety.

### BACKGROUND OF THE INVENTION

1. Field of the Invention

The present invention relates generally to a method for searching for a network in a radio communication system. More particularly, the present invention relates to a method for increasing the network search rate of a UE (User Equipment) adapted for manual network selection.

2. Description of the Related Art

As generally known in the art, in a common cell, radio communication systems rely on system information messages to provide UEs, with information necessary to access a network.

Such system information messages typically include a scheduling block containing information regarding various types of systems, an MIB (Master Information Block) containing network information, and a plurality of SIBs (System Information Blocks). System information messages are periodically sent to UEs. Each SIB may be divided into a plurality of blocks.

UEs receive system information messages from a network in charge of a cell to which the UEs belong, such as a UTRAN (UMTS Terrestrial Radio Access Network), via a predetermined channel, such as a BCCH (Broadcast Control Channel). Based on the system information messages received. UEs obtain information necessary to access a network, such as core network information and/or network information.

UEs commonly observe the following procedure to maintain a connection with a network.

The network (UTRAN) periodically broadcasts system information messages. UEs receive the system information message from the network, read it, and maintain a connection with the network based on the system information message. A conventional operation for maintaining the network connection will now be described with reference to FIG. 1.

FIG. 1 shows a conventional method for searching for a network in a radio communication system. More particularly, FIG. 1 is a brief overview of the method steps for manually selecting a network by a UE in a radio communication system according to the prior art.

With reference to FIG. 1, a user requests manual network selection (S101). Then, at step (S103), from a system information message received from the network, the UE reads the entire SIB of all PLMNs (Public Land Mobile Networks), which exist neighbor (i.e. within a communication range of) the UE. The UE obtains the list of the corresponding PLMNs from the SIB and displays the list on the screen (S105). The user selects a desired PLMN from the PLMN list (S107). Then, the UE accesses the PLMN selected by the user and conducts data communication as requested by the user.

As such, according to the prior art, the UE reads the SIB of all PLMNs obtained from a system information message, which is received from the network, and displays a PLMN list. This causes a time delay because the UE must read the SIB of all searchable PLMNs from a system information message received from the network and display a corresponding PLMN list. Consequently, the network search rate of the UE decreases.

Therefore, there is a need in the art to provide a new method for UE searches that has a faster rate than conventionally known heretofore.

### SUMMARY OF THE INVENTION

Accordingly, the present invention has been made in part to solve at least some of the above-mentioned problems discussed herein above. The present invention provides a method of searching for a network in a radio communication system, wherein a UE can search for a network at an improved rate.

Additionally, the present invention also provides a method of searching for a network in a radio communication system, wherein, when a UE selects a PLMN, the SIB of the selected PLMN is read solely from a system information message, so that the network search time is shortened.

Furthermore, the present invention provides a method of searching for a network in a radio communication system, wherein the Location Area Code (LAC) is added solely to the MIB of a system information message, so that, when a UE selects a PLMN, the PLMN list can be displayed without having to read the entire SIB of all PLMNs.

In addition, the present invention provides a method of searching for a network in a radio communication system, wherein the MIB of a system information message is solely read to display a PLMN list and, when the user selects a PLMN, the remaining SIB of the selected PLMN is read so that the network search time is shortened.

Further to the above, the present invention has additional technical aspects not described herein above, which can be clearly understood by those skilled in the art from the following description.

In accordance with one exemplary aspect of the present invention, there is provided a method for searching for a network in a radio communication system, the method including: reading an MIB of a system information message received from a network in conjunction with a manual network selection request by a UE; displaying a list of searched PLMNs based on the MIB; reading an SIB of a PLMN from the system information message, the PLMN having been selected from the list; and accessing the PLMN.

In accordance with another exemplary aspect of the present invention, there is provided a method for searching for a network in a radio communication system, the method including: a network periodically broadcasting a system information message having an MIB containing location area information regarding at least one PLMN of the network; and a UE reading the MIB of the system information message received from the network during a network search by the UE, displaying a PLMN list, and reading an SIB of a PLMN selected from the PLMN list.

In accordance with yet another exemplary aspect of the present invention, there is provided a method for accessing a network in a radio communication system, the method including: reading an MIB of a system information message received from a network at a request of a user; displaying a list of obtained PLMNs based on the MIB; reading an SIB when a PLMN is selected from the list; and accessing the selected PLMN based on the read SIB and conducting wired data communication as requested by the user.

Particulars of some of the other exemplary aspects and embodiments of the present invention are discussed in the following description in conjunction with the attached drawings.

### BRIEF DESCRIPTION OF THE DRAWINGS

The above and other exemplary aspects, features and advantages of the present invention will be more apparent from the following detailed description taken in conjunction with the accompanying drawings, in which:

FIG. 1 shows a conventional method for searching for a network in a radio communication system: and

FIG. 2 shows a method for searching for a network in a radio communication system according to an exemplary embodiment of the present invention.

### DETAILED DESCRIPTION OF THE INVENTION

Advantages and features of the present invention, and ways to achieve said advantages and features, will be apparent from the description herein below together with the accompanying drawings. However, the scope of the present invention is not limited to such exemplary embodiments, which have been provided for illustrative purposes and not to limit the scope of the invention, as the present invention may be realized in various forms. The exemplary embodiments described herein below are to assist those skilled in the art to understand the present invention. Accordingly, there are various modifications that an artisan understands are within the spirit of the invention and the scope of the appended claims. In addition, the same reference numerals are used to designate the same elements throughout the specification.

Those skilled in the art can easily understand that the construction described and shown in the specification and drawings corresponds only to a preferred exemplary embodiment of the present invention, and does not include a discussion of known functions and descriptions when such inclusion would obscure the appreciation of the present invention with a description of such known functions. Hereinafter, exemplary embodiments of the present invention will be described with reference to the accompanying drawings.

According to one exemplary embodiment of the present invention, a Location Area Code (LAC) field is added to a Master Information Block (MIB), which is a basic element of the system information message. This makes it possible to display a Public Land Mobile Network (PLMN) list without having to read the entire System Information Block (SIB) of all PLMNs, which are searched by the UE based on the system information message.

Another exemplary embodiment of the present invention provides a method for searching for a network in a radio communication system, wherein, when a UE selects a PLMN from the PLMN list, the UE does not read the entire SIB of all PLMNs, but only the SIB of the selected PLMN, so that manual network search time is shortened.

The LAC field contains location area information regarding at least one PLMN defined by each network constituting a cell. For example, network A contains LAC 0001 and LAC 0002, and network B contains LAC 0002 and LAC 0003. In general, information necessary to identify a network, in which the UE is currently functioning, is obtained from the corresponding network of a cell to which the UE belongs. Based on the network identification information and information regarding a location area, the UE searches for corresponding PLMN information.

For example, when Extended Operator Name Services (EONS) information is used, LAC 0001-0002 of a specific PLMN indicates a network named “A,” not the name of a different network that can be associated with the PLMN. If the UE of a specific PLMN is operating in LAC 0003, the UE may indicate a network name “B.”

Thus, the UE reports any changes occurring in its location area to the to corresponding network of a cell to which the UE belongs.

The networks include 2G (2^{nd} generation) Global System for Mobile Communications (GSM) radio access networks, 2.5G GSM and Code Division Multiple Access (CDMA) networks, 3G Universal Mobile Telephone System (UMTS) and Wideband Code Division Multiple Access (WCDMA) networks, other types of communication networks, and combinations thereof. The networks are widely known in the art, and detailed description thereof will be omitted herein.

The UEs include every type of communication equipment adapted for at least one communication protocol, such as International Mobile Telecommunication 2000 (IMT-2000), Time Division Multiple Access (TDMA), Global System for Mobile Communication (GSM), CDMA, UMTS, and WCDMA. Furthermore, the UEs include all types of information communication devices, multimedia devices, and variations thereof, which can communicate with networks, such as a Portable Multiple Player (PMP), an MP3 player, a digital broadcast receiver, a Personal Digital Assistant (PDA), a smart phone, a mobile phone, and a laptop computer.

According to an exemplary embodiment of the present invention, the information existing in the MIB of a system information message is sufficient to display a PLMN list, which is obtained by a UE from the system information message sent by the network. Considering the aforementioned sufficiency regarding the MIB information to display the PLMN list, only the MIB is read from the system information message, and the obtained PLMN list is then displayed. When the user selects a desired PLMN from the PLMN list, the UE reads the SIB of the selected PLMN.

The advantage of the UE not reading the SIB of all PLMNs obtained from the system information message is a reduced manual network search time. This improves the network search rate of the UE.

To this end, the MIB of a system information message must contain sufficient information for a PLMN selection. A conventional MIB has a format as shown in the following Table 1.

TABLE 1
CONVENTIONAL METHOD

| Information | | | | |
|---|---|---|---|---|
| Element/ | | | Type and | Semantic |
| Group name | Need | Multi | reference | description |
| Other information | | | | |
| elements | | | | |
| MIB value tag | Mandatory | | MIB Value | |
| | Present(MP) | | tag 10.3.8.9 | |
| Core Network (CN) | | | | |
| information | | | | |
| elements | | | | |
| Supported PLMN | Mandatory | | PLMN type | |
| types | Present | | 10.3.1.12 | |
| | (MP) | | | |
| PLMN Identify | CV-GSM | | PLMN Identify | |
| | | | 10.3.1.11 | |

Note that column “Multi” stands for a value range when corresponding “Information Element” supports “Multi”. The rows “Other Information Elements” and “CN information Elements” are fields for indicating a sort of Information Element i.e. the row “CN information Elements” indicates information elements on Core Network. It is clear from Table 1 that, in the case of an existing PLMN selection method, the PLMN Identify field described in Table 1 is sufficient to display a PLMN list. However, in the case of a PLMN supporting EONS, for example, different PLMN names must be displayed by using a LAC, even if the PLMN Identify is the same.

Therefore, according to an exemplary embodiment of the present invention, a LAC is added as an information element of the MIB, which is related to at least one location area defined by each network constituting a cell, as defined by following Table 2. Based on this, even the case of a PLMN supporting EONS, for example, can be considered according to the present embodiment.

TABLE 2
PRESENT INVENTION

| Information | | | Type and | |
|---|---|---|---|---|
| Element/Group name | Need | Multi | reference | Semantic description |
| Other information | | | | |
| elements | | | | |
| MIB value tag | Mandatory | | MIB Value | |
| | Present | | tag | |
| | (MP) | | 10.3.8.9 | |
| Core Network (CN) | | | | |
| information elements | | | | |
| Supported PLMN types | Mandatory | | PLMN type | |
| | Present | | 10.3.1.12 | |
| | (MP) | | | |
| PLMN Identify | CV-GSM | | PLMN | |
| | | | Identify | |
| | | | 10.3.1.11 | |
| LAC | CV-GSM | | Bit string (16) | The first/left most bit of |
| | | | | the bit string contains |
| | | | | the most significant bit |
| | | | | of the LAC. |

It is clear from Table 2 that the present exemplary embodiment proposes to read primarily only the most basic MIB during a PLMN search and display a PLMN list. The basic reading shortens the time needed by the UE to search for a PLMN. In addition, the adding of an LAC to the MIB avoids any problem expected to occur when the SIB is not read.

An example of how a method for improving the network search rate according to the present invention, particularly operations for shortening manual network search time according to an exemplary embodiment of the present invention, will now be described. However, those skilled in the art will easily understand that the present invention is not limited to the technical details described herein, but is applicable to various embodiments without any limitation from the illustrative examples presented for explanatory purposes.

FIG. 2 shows a method for searching for a network in a radio communication system according to an exemplary embodiment of the present invention. Particularly, FIG. 2 shows a method for manually selecting a network by a UE in a radio communication system according to an exemplary aspect of the present invention.

It will be assumed in conjunction with the steps shown in FIG. 2 that a network (e.g. UTRAN), to which a UE belongs, periodically broadcasts a system information message, which includes a LAC newly added to its MIB, as well as other pieces of system information constituting the message. The LAC corresponds to location area information regarding at least one PLMN defined by the network constituting a cell to which the UE belongs.

Referring to FIG. 2, a user requests manual network selection (S201). Then, at step (S203) the UE reads an MIB from a system information message received from the network. After reading the MIB from the system information message, the UE displays a PLMN list, which is obtained from information provided in the MIB (S205).

In contrast with the example shown in FIG. 2, in conventional methods, when the user requests a manual network selection, the UE reads the entire SIB of all PLMNs, which exist neighbor (i.e. within a communication range of) the UE, from a system information message received from the network, and displays a PLMN list accordingly. This type of display of a PLMN list inevitably causes a time delay.

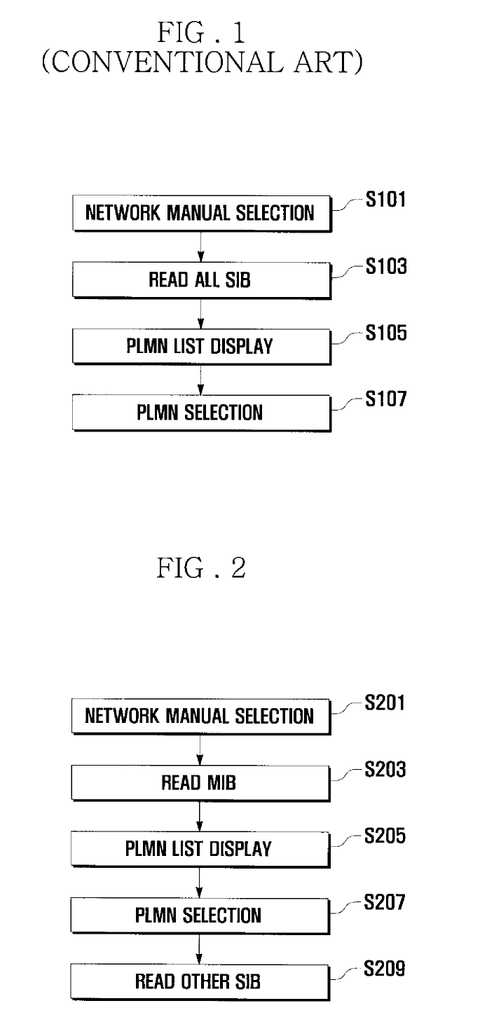

Considering the aforementioned, according to an exemplary embodiment of the present invention, a newly constructed MIB is read solely from the system information message, as shown in FIG. 2, and reference is made to the LAC field of the MIB to display a PLMN list, without reading all the SIBs as in the conventional method exemplified in FIG. 1. This approach shortens the time necessary for a manual search and display of a PLMN list when the user requests manual network selection.

In other words, the present invention provides a new type of system information message, which includes an MIB having an LAC field added thereto as shown in FIG. 2, in contrast to conventional system information messages. The network broadcasts the newly constructed system information message to the UE, and the LAC field added to the MIB facilitates reducing the number of steps that are performed in a conventional method/system by a U.E.

When the user selects a desired PLMN from the displayed PLMN list (S207), the UE reads only the SIB of the selected PLMN (S209). In other words, the UE does not read the SIB of all PLMNs, but only the SIB of the selected PLMN based on the LAC field added to the MIB.

Then, the UE can access the PLMN selected by the user and conduct wired data communication as requested by the user.

In summary, according to the present exemplary embodiment, the UE typically reads only the MIB (containing the LAC field) to display a PLMN list. It is not until the user selects a PLMN that the remaining SIB of the PLMN is read. This shortens the manual search time.

Particularly, the most basic MIB is read solely during a PLMN search. This reduces the time necessary to search for a PLMN. Furthermore, addition of a LAC to the MIB of the system information message avoids any problem expected to occur when the entire SIB is not read.

As mentioned above, the method for searching for a network in a radio communication system according to the present invention is advantageous in that, when the UE manually selects a network, the manual search time is shortened.

In addition, a code for PLMN selection is added to the MIB of a system information message, which is transmitted from a network to a UE. This shortens the time needed by the UE to search for and display a PLMN list and, consequently, the manual search time of the UE.

When the user selects a desired PLMN from the PLMN list displayed by the UE, (S207) the SIB of the selected PLMN is read from the system information message without reading all the SIBs at the same time. This shortens the manual search time.

According to the present invention, the UE merely reads the MIB to display the PLMN list. It is not until the user selects a PLMN that the UE reads the remaining SIB of the PLMN (S209). This process shortens the manual search time and improves the overall network search rate.

Particularly, the most basic MIB is solely read during a PLMN search. This reduces the time necessary to search for a PLMN. Furthermore, addition of a LAC to the MIB avoids any problem expected to occur when the entire SIB is not read.

The effects of the present invention are not limited to the above-mentioned effects, and other effects not mentioned above can be clearly understood from the definitions in the claims by one skilled in the art.

Although exemplary embodiments of the present invention have been described for illustrative purposes, those skilled in the art will appreciate that various modifications, additions and substitutions are possible, without departing from the spirit of the invention and the scope of the appended claims. Therefore, the embodiments described above should be understood as illustrative not restrictive in any aspect disclosed.

What is claimed is:

1. A method of searching for a network in a radio communication system, the method comprising:
(a) reading a Master Information Block (MIB) by a User-Equipment (UE) of a system information message received from a network in response to a manual network selection request;
(b) displaying a list of searched Public Land Mobile Networks (PLMNs) based on the reading of the MIB;
(c) reading a System information Block (SIB) of a PLMN from the system information message, the PLMN having been selected from the list; and
(d) accessing the PLMN.

2. The method according to claim 1, wherein the MIB of the system information message includes a Local Area Code (LAC) field that corresponds to location area information regarding at least one PLMN of the PLMNs displayed in step (c) and defined by the network constituting a cell to which the UE belongs.

3. The method according to claim 1, wherein in response to selecting the desired PLMN from the displayed PLMN list, reading, by the UE, of only the SIB of the selected PLMN based on the LAC field of the MIB.

4. The method of claim 1, which further comprises periodically broadcasting a system information message by the network, wherein an MIB of the system information message includes Local Area Code (LAC) comprising location area information regarding PLMNs.

5. The method of claim 2, which further comprises periodically broadcasting a system information message by the network, including Local Area Code (LAC) corresponding to location area information regarding PLMNs.

6. The method of claim 4, wherein the location area information is related to at least one PLMN defined by the network constituting a cell, the UE belonging to the cell.

7. The method of claim 1, which further comprises composing and displaying a PLMN list with reference to location area information of the MIB by the UE.

8. The method of claim 4, wherein the UE reads only the SIB of the selected PLMN based on the location area information in the LAC codes.

9. A method of searching for a network in a radio communication system, the method comprising:
periodically broadcasting a system information message having a Master Information Block (MIB) containing location area information regarding at least one Public Land Mobile Network (PLMN) by a network; and
reading the MIB of the system information message received from the network during a network search by a User-Equipment (UE), displaying a PLMN list, and reading a System Information Block (SIB) of a PLMN selected from the PLMN list.

10. The method of claim 9, which further comprises obtaining at least one PLMN existing neighbor the UE based on the location area information contained in the MIB of the system information message and displaying a list of the obtained PLMN by the UE.

11. The method of claim 10, wherein the location area information comprises a location area code (LAC) regarding at least one PLMN defined by the network constituting a cell, the UE belonging to the cell.

12. A method for accessing a network in a radio communication system, the method comprising:
reading a Master Information Block (MIB) of a system information message received from a network from a user-equipment (UE);
displaying a list of obtained Public Land Mobile Networks (PLMNs) based on the MIB;
reading a System Information Block SIB in response to a PLMN being selected from the list of PLMNs; and
accessing the selected PLMN based on the read SIB and conducting data communication as requested by the user.

13. The method of claim 12, wherein the displaying comprises displaying a list of obtained PLMNs based on a location area information field of the MIB.

14. The method of claim 13, wherein the location area information is a location area code (LAC) regarding at least one PLMN defined by a network constituting a cell, the UE belonging to the cell.

15. The method of claim 8, wherein the reading an SIB comprises reading only an SIB of the selected PLMN instead of an SIB of all PLMNs obtaining a location area field of the MIB.

16. A system for a radio communication network comprising a system information message in accordance with claim 2.
